(19) United States
(12) Patent Application Publication
(10) Pub. No.: US 2014/0063259 A1
(43) Pub. Date: Mar. 6, 2014

(54) METHOD AND SYSTEM FOR VIDEO PRODUCTION

(71) Applicants: Steven David Rhodus, Lexington, KY (US); Luther Andal, Lexington, KY (US); Mingyong Huang, Lexington, KY (US); Timothy Campbell, Lexington, KY (US)

(72) Inventors: Steven David Rhodus, Lexington, KY (US); Luther Andal, Lexington, KY (US); Mingyong Huang, Lexington, KY (US); Timothy Campbell, Lexington, KY (US)

(73) Assignee: IHIGH.COM, INC., Lexington, KY (US)

(21) Appl. No.: 13/601,501

(22) Filed: Aug. 31, 2012

(51) Int. Cl. H04N 5/225

(52) U.S. Cl. CPC H04N 5/225
USPC 348/157; 348/207.1

(57) ABSTRACT

Methods, systems, and apparatuses for video broadcast production are disclosed. A method for video broadcast production may be implemented by a computing device. A video stream is captured. An external date is inserted at a point of interest in the video stream. The external data facilitates display of content from an external source at the point of interest in the video stream. An encoded video stream including the external data inserted at the point of interest in the video stream is generated.

### FIELD

The present disclosure relates to methods and systems for video production. More particularly, the present disclosure relates to encoding and streaming video streams.

### BACKGROUND OF THE INVENTION

Broadcasters typically provide video production and broadcasting of events, such as theatrical events, news events, entertainment events, sporting events, or other events by capturing video from an event. The video data is subsequently sent to a remote studio for editing and addition of other production features. The additional production features may include manipulation of the broadcast such as adding graphics or selecting different cameras. However, this requires a dedicated and remotely located video studio to facilitate broadcasts.

Additionally, production trucks in general are actual trucks that include video productions equipment facilitating remote broadcasts and multiple camera setups. Generally, a large crew is required, oftentimes as many as 12-16 people. Additionally, extra production equipment may be stored in other trucks that follow a main production truck, including in addition, an uplink truck that facilitates transmission of the video feed produced by the production truck. Certain embodiments of a production truck may only require one truck to save space and resources. However, these trucks still require at least 2-3 people to manage the truck and produce video feeds for transmission. Additionally, special equipment is required, which still keeps the costs of running a production truck very high.

### SUMMARY

The embodiments described herein relate to methods and systems for encoding and streaming video streams.

In an embodiment, a method for video broadcast production implemented by a computing device is disclosed. A video stream is captured. An external date is inserted at a point of interest in the video stream. The external data facilitates display of content from an external source at the point of interest in the video stream. An encoded video stream including the external data inserted at the point of interest in the video stream is generated.

In another embodiment, capturing a video stream occurs at a production truck device comprising a video capture unit. The video capture unit may be configured to execute on at least one of: a desktop computing device, a mobile computing device, or via a web browser enabled device via a web browser.

In another embodiment, the point of interest in the video stream is determined based on an identified specific time in the video stream to insert an advertisement of a specific length. Metadata may be inserted at the point of interest in the video stream, wherein the metadata, when evaluated by a video player, allows the video player to request an advertisement.

In another embodiment, a score ticker may be inserted including local scores associated with select local games associated with an event shown in the video stream.

In another embodiment, statistics related to an event shown in the video stream may be inserted from an external source. The external source may be at least one of: an electronic stadium scoreboard or an official statistics computer feed from a scorekeeper.

In another embodiment, imported comments related to an event shown in the video stream may be inserted, the imported comments received from users via text message or email.

In another embodiment, a live video feed may be inserted from an external source, the live video feed being related to an event shown in the video stream.

In another embodiment, a graphical template may be inserted within the video stream.

In another embodiment, the encoded video stream may be transmitted to a video server for distribution.

In another embodiment, the encoded video stream may be transmitted to a central distribution network for distribution.

In another embodiment, the encoded video stream may be transmitted to a video player of a user to play the encoded video stream. The video may operate in at least one of: a website, a mobile application, a mobile website, or a widget within an application.

In an embodiment, a system for encoding and streaming video streams is disclosed. The system may comprise a video capture unit, a video server, and a database. The video capture unit may be configured for capturing a video stream, inserting external data in the video stream, and encoding the video stream including the external data. The video server may be configured for distributing the encoded video stream. The database may be configured for storing information related to the video stream, the external data, and distribution of the video stream.

In another embodiment, the system further comprises a user interface unit, coupled to the video capture unit, configured for determining a point of interest in the video stream; and facilitating insertion of the external data at the point of interest in the video stream, the external data facilitating display of content from an external source at the point of interest in the video stream.

In another embodiment, the system is at least one of: a desktop computing device, a mobile computing device, or a web browser enabled device.

In another embodiment, the system further comprises an advertisement unit configured for inserting metadata at a point of interest in the video stream, wherein the metadata, when evaluated by a video player, allows a video player to request an advertisement.

In another embodiment, the system further comprises a user interface unit, coupled to the video capture unit, configured for inserting a score ticker including local scores associated with select local games associated with an event shown in the video stream.

In another embodiment, the system further comprises a user interface unit, coupled to the video capture unit, configured for inserting statistics related to an event shown in the video stream from an external source, wherein the external source is at least one of: an electronic stadium scoreboard or an official statistics computer feed from a scorekeeper.

In another embodiment, the system further comprises a user interface unit, coupled to the video capture unit, configured for inserting imported comments related to an event shown in the video stream, the imported comments received from users via text message or email.

In another embodiment, the system further comprises a user interface unit, coupled to the video capture unit, configured for inserting a graphical template tailored for content within the video stream.

In another embodiment, the video server is configured for transmitting the encoded video stream to a central distribution network for distribution.

In another embodiment, the video server is configured for formatting the encoded video stream in at least one format of a plurality of formats; and transmitting the formatted encoded video stream to a video player.

In another embodiment, the system further comprises an advertisement server for storing third party advertisements; and the video capture unit is further configured for retrieving third party advertisements form the advertisement server; and inserting the third party advertisements into the video stream.

In another embodiment, the system further comprises a video player configured for receiving the encoded video stream from the video server. The video player may reside in at least one of: a website, a mobile application, a mobile website, or a widget within an application.

In another embodiment, the system further comprises a user interface unit, coupled to the video capture unit, configured for inserting metadata into the video stream, wherein the metadata, when evaluated by a video player playing the video stream, causes the video player to retrieve an advertisement from an ad server to play in the video stream at a particular time for a particular length. The database may further be configured to receive an indication that the metadata caused an advertisement to be played at the video player.

In another embodiment, the video player retrieves the advertisement from the ad server based on an analysis of media consumption preferences of a user of the video player.

In another embodiment, the system further comprises a scheduler configured for scheduling a broadcast of the video stream. The scheduler may comprise a web application accessibly by a user to schedule the broadcast of the video stream or edit an existing schedule. The database may be further configured to store broadcast schedule generated by the scheduler. The system may further comprise a web scheduler unit configured for facilitating updates to broadcast schedules stored in the database; and adding new broadcast schedules to the database. The system may further comprise a video management system configured for providing a user interface to at least one of: allow a user to associate additional information with the video stream, set limits on distribution of the video stream, and access analytics relating to the video stream.

In another embodiment, the external data comprises data associated with a score operator, wherein the data facilitates live updates to a video player playing the video stream in response to the score operator updating the data.

In another embodiment, the external data comprises an instruction to update a graphical interface of a video player.

In another embodiment, the video capture unit is further configured for receiving a plurality of video feeds from a plurality of recording devices.

In an embodiment, a machine readable non-transitory and tangible medium for encoding and streaming video streams, including information, that when executed, causes the machine to perform steps is disclosed. The steps may comprise: capturing a video stream; inserting external data in the video stream, the external data facilitating display of content from an external source in the video stream; and generating an encoded video stream including the external data inserted in the video stream.

In another embodiment, the information causing the machine to perform capturing a video stream comprises information causing the machine to perform the steps of: allowing a user to switch between a plurality of different recording devices to provide a feed to the video stream; and selecting one of the plurality of different recording devices to provide the feed to the video stream.

In another embodiment, the information causing the machine to perform inserting external data in the video stream comprises information causing the machine to perform the steps of: selecting a point of interest within the video stream; and inserting the external data at the point of interest. The external data may comprise at least one of: an overly, overlay images, local advertisements, or metadata for instructing a video player to retrieve an advertisement.

In another embodiment, the information causing the machine to perform selecting a point of interest within the video stream comprises information causing the machine to perform the step of: receiving an input indicating a point of interest based on a specified time in the video stream.

In another embodiment, the information causing the machine to perform inserting external data in the video stream comprises information causing the machine to perform the step of: inserting a score ticker including local scores associated with select local games associated with an event shown in the video stream.

In another embodiment, the information causing the machine to perform inserting external data in the video stream comprises information causing the machine to perform the step of: inserting statistics related to an event shown in the video stream from an external source, wherein the external source is at least one of: an electronic stadium scoreboard or an official statistics computer feed from a scorekeeper.

In another embodiment, the information causing the machine to perform inserting external data in the video stream comprises information causing the machine to perform the step of: inserting imported comments related to an event shown in the video stream, the imported comments received from users via text message or email.

In another embodiment, the information causing the machine to perform inserting external data in the video stream comprises information causing the machine to perform the step of: inserting a live video feed from an external source, the live video feed being related to an event shown in the video stream.

In another embodiment, the information causing the machine to perform inserting external data in the video stream comprises information causing the machine to perform the step of: inserting a graphical template tailored for content within the video stream.

In another embodiment, the information, when executed, further causes the machine to perform the step of: transmitting the encoded video stream to a video server for distribution.

In another embodiment, the information, when executed, further causes the machine to perform the step of: transmitting the encoded video stream to a central distribution network distribution.

In another embodiment, the information, when executed, further causes the machine to perform the step of: transmitting the encoded video stream to a video player of a user to play the encoded video stream. The video player may reside on at least one of: a website, a mobile application, a mobile website, or a widget within an application.

Additional advantages and novel features will be set forth in part in the description which follows, and in part will become apparent to those skilled in the art upon examination of the following and the accompanying drawings or may be learned by production or operation of the disclosed embodiments. The advantages of the present embodiments may be realized and attained by practice or use of various aspects of the methodologies, instrumentalities and combinations set forth in the detailed description set forth below.

### BRIEF DESCRIPTION OF THE DRAWINGS

The exemplary embodiments described herein may be described in detail with reference to the drawings. These embodiments are non-limiting exemplary embodiments, in which like reference numerals represent similar structures throughout the several views of the drawings.

FIG. 1 depicts an exemplary system for encoding and streaming video streams, in accordance with an embodiment of the present disclosure.

FIG. 2 depicts an exemplary system for encoding and streaming video streams, in accordance with an embodiment of the present disclosure.

FIG. 3 depicts an exemplary system for encoding and streaming video streams, in accordance with an embodiment of the present disclosure.

FIG. 4 illustrates a high level depiction of an exemplary system for encoding and streaming video streams to end users, in accordance with an embodiment of the present disclosure.

FIG. 5 illustrates a high level depiction an exemplary system for ad insertion into video streams distributed to end users, in accordance with an embodiment of the present disclosure.

FIG. 6 depicts an exemplary display of a production truck user interface, in accordance with an embodiment of the present disclosure.

FIG. 7 depicts an exemplary display of a production truck user interface, in accordance with an embodiment of the present disclosure.

FIG. 8 depicts an exemplary display of a production truck user interface, in accordance with an embodiment of the present disclosure.

FIG. 9 depicts an exemplary display of a production truck user interface, in accordance with an embodiment of the present disclosure.

FIG. 10 depicts an exemplary display of a production truck user interface, in accordance with an embodiment of the present disclosure.

FIG. 11 depicts an exemplary process for generating an encoded video stream, in accordance with an embodiment of the present disclosure.

FIG. 12 depicts an exemplary process for initiating ad placement and transmitting an encoded video stream, in accordance with an embodiment of the present disclosure.

FIG. 13 depicts an exemplary process for scheduling broadcasts of video streams, in accordance with an embodiment of the present disclosure.

FIG. 14 depicts a general machine architecture on which the present embodiments can be implemented and has a functional block diagram illustration of a hardware platform which includes user interface elements.

### DETAILED DESCRIPTION

The present disclosure relates to methods and systems for video production. More particularly, the present disclosure relates to encoding and streaming video streams. In accordance with the present disclosure, a production truck device is disclosed which is capable of capturing a video steam, inserting external data into the video stream, and generating an encoded video stream including the external data for transmission to video servers, content distribution networks, or end user video players is disclosed. The production truck device may comprise any desktop computing device (i.e., a personal computer, a workstation, a server), any mobile computing device (i.e., a laptop computer, a smartphone, a tablet computer), any web browser enabled device that is capable of executing web browser based software, and any other devices that may comprise in whole or in part any of the aforementioned, such as, for example, an automobile or other vehicle that includes a computing device that may be web browser enabled. The production truck device may include, for example, a production truck unit comprising software that facilitates the capture of video streams, and encoding of video streams for eventual transmittal to a video server, content distribution network, or video player.

Video streams are captured by the production truck device based on video feeds received from any of a plurality of cameras associated with the production truck device. The video stream may comprise a video feed from one camera, or be a combination of video feeds from different cameras in order to take into account different angles and locations of an event. Thus, the video streams captured by the production truck device are eventually encoded at the production truck device and the encoded video stream is transmitted or streamed to a video server. The video server may transcode the encoded video stream into a plurality of formats to ensure that the video stream is playable by video players. The transcoded video stream may then be either transmitted to a content distribution network for distribution or the video server may stream the transcoded video stream directly to an end user device comprising a video player.

The video server may reside at the same location as the production truck device or be integrated with the production truck device. The video server may comprise software which is capable of receiving the encoded video stream from the production truck device and transcoding the encoded video stream into a plurality of formats. The video server may directly stream the transcoded video stream to video players. Thus, in an embodiment, where the video server is integrated with the production truck device, the production truck device may directly stream a transcoded video stream directly to an end user device including a video player. In another embodiment, the video server transmits the transcoded video stream to a content distribution network, which may comprise a large distributed system of servers to stream the transcoded video stream to end user devices.

The end user device may be comprise any desktop computing device (i.e., a personal computer, a workstation, a server), any mobile computing device (i.e., a laptop computer, a smartphone, a tablet computer), any web browser enabled device that is capable of executing web browser based software, and any other devices that may comprise in whole or in part any of the aforementioned, such as, for example, an automobile or other vehicle that includes a computing device that may be web browser enabled, similar to the production truck device. The end user device may comprise a video player to play any video stream that is transmitted to the end user device.

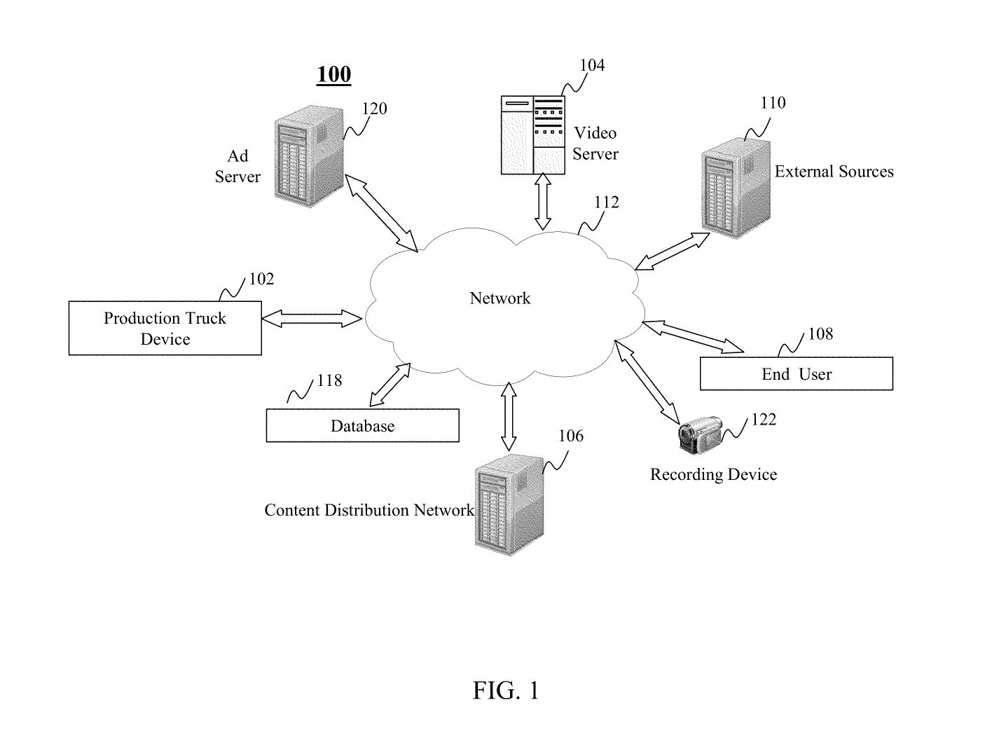

FIG. 1 depicts an exemplary system for encoding and streaming video streams, in accordance with an embodiment of the present disclosure. System 100 as shown, includes a production truck device 102, video server 104, content distribution network 106, end user device 108, external sources 110, database 118, ad server 120, and recording devices 122. Communication between any of the aforementioned devices may take place over network 112. While only one production truck device, video server, ad server, and end user device are shown, it is understood that the system may comprise a plurality of production truck devices, video servers, ad servers, and end user devices.

Production truck device 102, as described above, provides a user with the ability to capture video streams which are encoded and streamed to other devices such as video server 104, content distribution network 106, or end user 108. The video streams that are captured are based on video feeds provided by recording devices 122. At least one recording device 122 is required for transmitting a video feed to production truck device 102 in order to facilitate capturing of a video stream. The recording device 122 may be any camera, video camera, or apparatus capable of recording video and/or audio, such as a smartphone, laptop, or personal computing device. In an embodiment, the recording device 122 may be integrated with the production truck device 102 or be the production truck device 102. The recording device 122 may also comprise separate components, such as a video recording component and an audio recording component. Production truck device 102, thus serves as the point of control to determine what the contents of the video stream are, and what is eventually streamed to other devices, such as an end user device 108 to be played by a video player and displayed by the end user device 108.

When there are more than one recording device 122 providing video feeds of events to production truck device 102, a user of production truck device 102 may have the option of deciding which of the video feeds to use for the current video stream. For example, if there are a two video feeds, each showing a different angle of the event, the user of production truck device 102 may select one of the two video feeds at any given time for use as the video stream being streamed to end user devices 108. Production truck device 102 also facilitates a picture-in-picture function where the video stream may show one video feed super-imposed by another video feed. For example, in a sporting event, a video feed from one recording device 122 of a game block may be added to the bottom right corner of the video stream, while the remaining portion of the video stream plays a video feed from another recording device 122 showing a football game. Thus, production truck device 102 facilitates mixing of and superimposing of different video feeds within the video stream.

Production truck device 102, in capturing the video stream, also facilitates management of multiple recording devices 122. Traditionally, video feeds to a production truck are typically provided by cameras associated with those at the production truck. In an embodiment, recording devices 122, as described above, do not need to be typical cameras and may comprise smartphones, which facilitate easy placement at events, and still provide high quality video feeds.

For example, recording devices 122 may be smartphones with the ability to capture video and audio and transmit the video feeds to production truck device 102. These smartphones may be set up to cover four different angles at a baseball game, and each smartphone or recording device 122 serves as a source of a video feed to production truck device 102 over network 112. Production truck device 102 manages a captured video stream that is streamed to end users 108 by controlling which particular video feed from a recording device 122 is used as part of the video stream that is streamed. To further facilitate mobility of the production truck device 102, the production truck device 102 may be a tablet computing device and thus control of the captured video stream to be broadcast can be controlled from any remote location either at the event or away from the event.

In an embodiment, production truck device 102 may also access recording devices 122 that are not associated with the production truck device 102 or the crew of the production truck device 102. Individual users, fans, or attendees of events may establish an account that allows their devices to be associated with the production truck device 102. Thus, these devices may also be included with recording devices 122 as sources of video feeds to production truck device 102. For example, if during a baseball game, a foul ball is hit to left field, but there is no dedicated recording device 122 with an association to production truck device 102 to provide a clear view of whether the ball is foul or fair, a user of production truck device 102 may have to option to switch to a fan recording device 122, such as a fan's iPhone which may provide a clear view of the ball. Thus the video feed from the fan recording device 122 may be provided as the video stream to end users 108. This thus allows anyone who attends an event to have an option of using their recording device 122 as a source for video feeds for those watching in order to facilitate a digitally interactive experience.

In the embodiments described above, capture of video streams may be facilitated by a video stream capture unit of production truck device 102. A user controls which video stream is streamed to end users 108 via a user interface provided by a user interface unit of production truck device 102.

Production truck device 102 may also include an advertisement insertion unit. The advertisement insertion unit provides a way for users to insert advertisements into a video stream at a specific time of the video stream and for a specific length. A user of the production truck device 102 may determine that at some point of the captured video stream, an advertisement should be inserted. Via the user interface of production truck device 102, a user may initiate a selection to begin the process of placing an advertisement within the video stream. As the video stream is streaming, the user may insert an advertisement slot at a specific time in the video stream and dictate the length of the advertisement slot. In an embodiment, an advertisement is inserted into the advertisement slot, and is transmitted as part of the video stream so that an end user 108 will see the advertisement.

In another embodiment, advertisement metadata is inserted into the video stream instead of an actual advertisement. The advertisement metadata contains information that determines which advertisement will be played at a particular end user device 108 based upon certain factors, such as the geographic location of end user device 108, demographic information related to the end user of end user device 108, and other information associated with viewing and purchasing preferences of the end user of end user device 108. After insertion of the advertisement metadata into the video stream by production truck device 102, the video stream is encoded and transmitted to video server 104, which may then either transmit the encoded video stream including advertisement metadata to a content distribution network 106, which will stream the video stream to end user devices 108, or the video server 104 may directly stream the video stream to end user devices 108 after transcoding the encoded video stream into different formats to ensure that the video stream will play at the end user devices 108.

When the video stream including advertisement metadata is received by end user device 108, the video stream is played. As a video player at end user device 108 plays the video, the video player will encounter the advertisement metadata within the video stream and proceed to evaluate the metadata to determine which advertisement to play. A determination of which advertisement to play may depend on several factors, including geographic location of the end user device 108, the type of content in the video stream, information gathered from other metadata stored at the end user device 108 which provide an indication of consumption preferences and purchasing preferences of an end user of the end user device 108. Based on this, the end user device 108 transmits a request to ad server 120 to request an advertisement. Ad server 120 may be a server dedicated to the storage of advertisements that are transmitted to various end user devices 108. Ad server 120 may be a central server for storage of multiple advertisements for multiple third parties, or it may be a central server affiliated with a single third party. Subsequently, ad server 120 transmits an advertisement to end user device 108 based on the evaluation of advertisement metadata at the end user device 108. The advertisement is then played by the end user device 108 at the specific point in time and for the specific length set at the production truck device 102.

Once an advertisement has been played, end user device 108 transmits an indication that the advertisement was played to database 118 for storage. Database 118 stores advertisement logs which keep track of which advertisements were played at which end user devices 108.

In addition to the features of the embodiment described above, production truck device 102 further provides several other functionalities. For example, in an embodiment, if a video stream is related to a sporting event, a user of production truck device 102 may add, via the user interface, a score ticker, into the video stream, which displays local scores from selected local games that are associated with the sporting event shown in the video stream or associated with the location of the sporting event shown in the video stream. The scores themselves may be retrieved from an external source 110, such as a server that provides updates of sports scores. Production truck device 102 may insert the sports ticker into the video stream, and after the video stream has been provided to an end user device 108, the ticker may make requests to an external source 110 for the scores, causing transmission of the scores to the ticker for display by the end user device.

In another embodiment, if a video stream is related to a sporting event, the score data relating to the sporting event may be exported from production truck device 102 to external sources 110. The external sources 110 in this instance may be scoreboard websites, mobile subscribers, and media partners. Each time score data relating to the sporting event is updated , production truck device 102 will export the score data to an external source 110 instantly so that the external source 110 will have live, up to date scores.

In another embodiment, data may be provided from external sources 110 to production truck device 102. This data may be, for example, data from electronic stadium scoreboards, or official statistics of a scorekeeper. Once external sources 110 transmits this data to production truck device 102, a user of production truck device 102 will have access to this data and be able to use the data to insert the data into a video stream. In the case of statistics, the statistics for a particular player shown in the video stream, for example, may be provided by an external source 110 to production truck device 102. A user of production truck device 102 may then, using the user interface, insert an overlay into the video stream that includes the statistics for the particular player when the particular player appears in the video stream.

In another embodiment, external sources 110 or end user devices 108 may send comments via text messages or email to production truck device 102. These comments are those that may be considered for addition to the broadcast. Once production truck device 102 receives the comments, a user of production truck device 102 may selectively choose certain comments to display at certain points within the video stream. For example, a ticker may be inserted at the bottom of a display of the video stream to show comments, such as “Go #78 Jeremy Smith, this is your year!—Marie Smith” and “50% with ticket stub, Marco's Pizza, Danville Bypass.”

In another embodiment, live video input from sources other than recording devices 122 may be provided to production truck device 102. This live video input may be provided to production truck device 102 from external sources 110. The live video input, may be, for example, an input from a video messaging service such as Skype. If the video stream is showing a sporting event in the city of Ithaca, New York between Cornell and Brown, the live video input may be an interview with a famous alumni of Cornell who is playing in the National Football League. After production truck device 102 receives the live video input, a user of production truck device 102 may choose to either use the live video input as the video stream for a period of time, or insert an overlay such as a picture in picture, to show the live video input concurrently with the video stream.

In another embodiment, production truck device 102 may retrieve social media information from external sources 110. For example, for sporting events, player information may be retrieved from a social networking site. This information may include statistics, photos, videos, a list of heroes of the player, favorite college and professional teams, and other information. The information may be retrieved from any social media outlet or social network, such as Facebook. The information may be retrieved manually by a user of production truck device 102 in response to identifying a certain player or individual within the video stream. The information may also be retrieved automatically by production truck device 102 as production truck device 102 detects the presence of certain individuals or players within the video stream. As a player is detected, production truck device 102 will transmit a query to an external source 110 which may be a social media network to retrieve all relevant information. Subsequently, this information will be linked to the player. The user of production truck device 102 may then insert the information for display within the video stream while the player or individual appears.

In another embodiment, production truck device 102 facilitates the insertion of graphical templates designed for specific events. These graphical templates may be inserted into the video stream via the user interface. For example, if the video stream provides a display of a volleyball game, a volleyball graphical template may be inserted, which provides custom formatting and a layout for insertion of statistics, statistical leaders, and summaries. The graphical templates may vary and be customized for each individual sport, and be different for other entertainment events such as symphonies and concerts. The appropriate graphical template may be selected via the user interface at the production truck device 102, which causes the graphical template to be inserted into the video stream. The insertion of the graphical template may also cause automatic insertion of other related data, such as statistics, and summaries, and player biographies related to any event shown by the video stream and the particular graphical template.

In another embodiment, the user interface of the production truck device 102 may include dynamic graphics based upon who the user is. A user may access the production truck device 102's user interface by logging in. Once log in is authenticated, the user will be able to use all of the functionalities of the production truck device 102 via the user interface. Upon login, production truck device 102 may retrieve a custom interface layout based on characteristics of the user. For example, all high school users in Atlanta may have a user interface layout that matches that of a local sponsor.

While a user interface is described, all functionalities described above may also be accessed via a web browser from the production truck device 102. Thus, production truck device 102 does not require any programs stored at the production truck device 102 in order to carry out the capture of video streams, insertion of external data into the video streams, and encoding of video streams for streaming to end users 108. Access via a web browser is advantageous because the production truck device 102 itself does not require as a large amount or resources or storage.

Encoded video streams may be provided by production truck device 102 to either a video server 104 or a content distribution network 106, or directly to end user devices 108. Video server 104, after receiving the encoded video stream including any external data from production truck device 102, shall transcode the video streams into other formats such as those playable by end user devices 108. Video server 104 may thus, serve as the distribution point to provide transcoded video streams in the proper format to end user devices 108, or alternatively provide the transcoded video streams to content distribution network 106 to distribute.

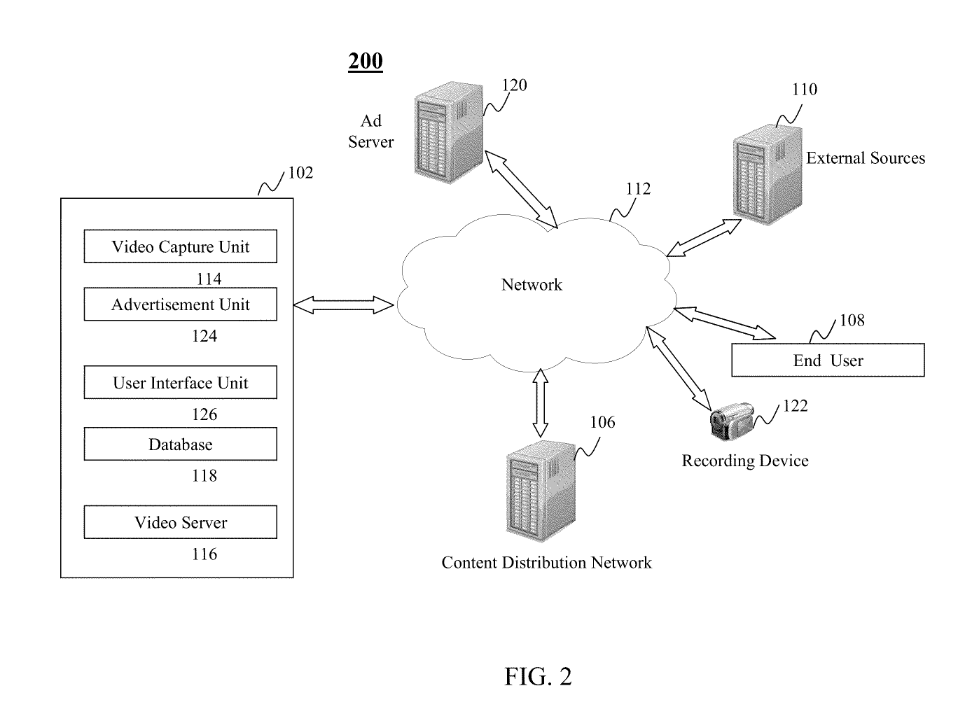

FIG. 2 depicts an exemplary system for encoding and streaming video streams, in accordance with an embodiment of the present disclosure. System 200, as shown, includes production truck device 102, content distribution network 106, end user devices 108, external sources 110, ad server 120, and recording devices 122. All of the aforementioned components may transmit and/or receive data via network 112 as shown. System 200 is substantially similar to system 100 as shown by FIG. 1. However, production truck device 102, in this instance, as shown, includes video capture unit 114, advertisement unit 124, user interface unit 126, database 118, and video server 116.

Video capture unit 114 may be configured for capturing video streams from the video feeds provided by recording devices 122. Advertisement unit 124 may be configured for inserting the aformentioned metadata or an advertisement into a video stream. User interface unit 126 is configured to provide a user interface to a user of production truck device 102 to allow the user to facilitate the capture of video streams, and insertion of metadata, advertisements, and other external data into the video stream before the video stream is distributed to end user devices 108. In the embodiment displayed by FIG. 2, production truck device 102 includes video server 116, and thus video capture unit 114 may produce an encoded video stream, that is then transcoded by video server 116 in order for the transcoded video stream to be transmitted to a content distribution network 106 or to end user devices 106 to play the video stream. Thus, instead of a separate video server 116 at a different location or in a different machine, production truck device 102 may include a video server 116. Production truck device 102 may further include database 118 for storage of any data relating to the capture of video streams, external data to be placed in the video stream, and any data related to advertisements.

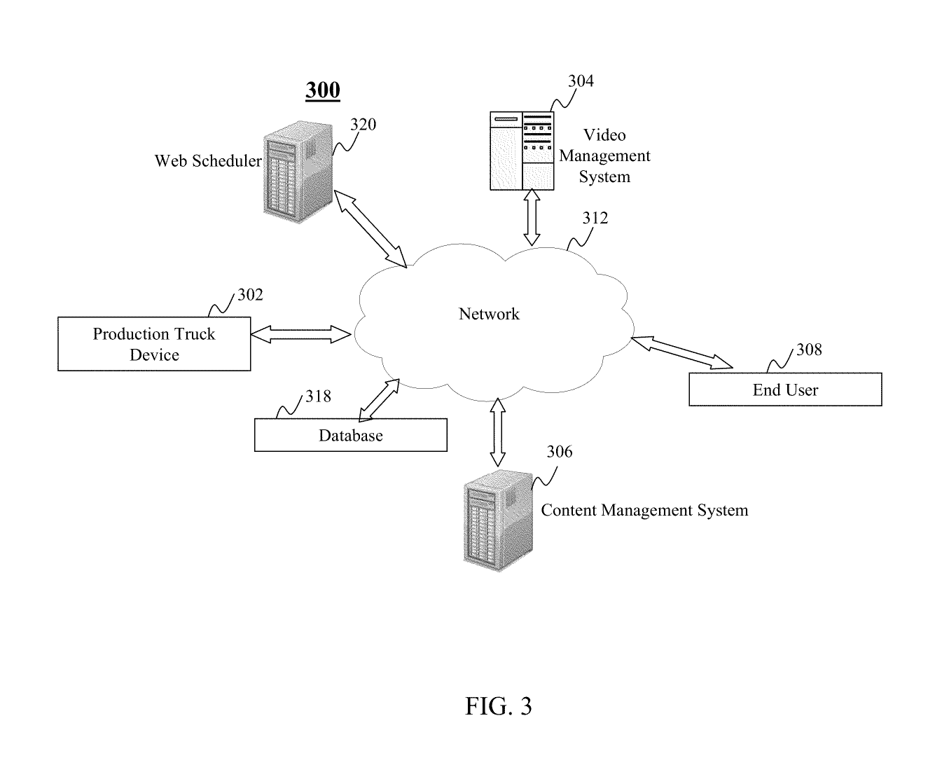

FIG. 3 depicts an exemplary system for encoding and streaming video streams, in accordance with an embodiment of the present disclosure. System 300 includes a production truck device 302, content management system 306, end user devices 308, video management system 304, network 312, database 318, and web scheduler 320. In an embodiment, production truck device 302 may be utilized for scheduling broadcasts of video streams. A user of production truck device 302 may, via user interface or scheduling unit of production truck device 302, schedule an upcoming broadcast of a video stream. Scheduling of an upcoming broadcast of a video stream may also be performed via web scheduler 320. After scheduling, the schedule or data indicating when a broadcast is scheduled for streaming as a video stream is saved to database 318 and video management system 304. Schedules may then be retrieved at predetermined polling intervals by content management system 306 from database 318. These schedules of video streams to be broadcast may then be formatted for display on a web site accessible by end user devices 308 to obtain broadcast schedules. This facilitates ease of use by end user devices 308 to know when certain video streams are to be broadcast, and also access the video streams from the web site.

The aforementioned paragraph is not only applicable to scheduling of broadcasting of video streams, but is also applicable to changing existing schedules.

Web scheduler 320 represents a web based application that facilitates a user adding a new broadcast schedule of a video stream or editing an existing broadcast schedule. Web scheduler 320 may be utilized, for example, when a user does not have access to production truck device 302, and wishes to change schedules from a different or remote location.

Production truck device 302 includes substantially the same functionalities of production truck device 102 as described above with respect to FIGS. 1 and 2. Production truck device 302 may further include a scheduling unit that provides functionality to a user of production truck device 302 to add a new broadcast schedule of a video stream or edit an existing broadcast schedule.

Although not shown explicitly by FIG. 3, there may exist a set of web services that allow an application to execute the functionality of production truck device 302 and web scheduler 320 via hypertext transfer protocol (HTTP) to pass data relating to scheduling to database 318 and/or video management system 304.

Video management system 304 represents an application accessible by users of production truck device 302, as well as users of end user devices 308 to associated additional information with a scheduled broadcast. The additional information may be related to certain individuals in the video stream of the scheduled broadcast or may relate to information related to the event of the video stream. Video management system 304 further facilitates placement of limitations on a scheduled broadcast. For example, a user may limit a scheduled broadcast to a certain locality. Age restrictions may also be placed on the broadcast of certain video streams. Video management system 304 also allows a user to view analytic information related to the broadcast of a video stream, such as amount of times viewed, duration of viewing time by particular users, or the location of users viewing the video stream.

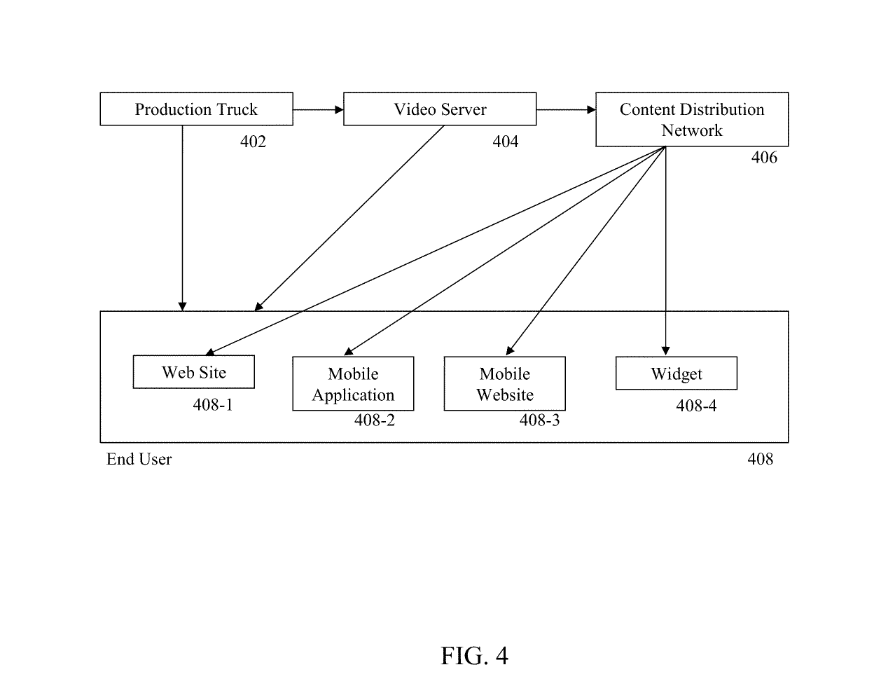

FIG. 4 illustrates a high level depiction of an exemplary system for encoding and streaming video streams to end users, in accordance with an embodiment of the present disclosure. FIG. 4 depicts a high level illustration of how captured video streams are transmitted to end user devices. Production truck device 402 receives video feeds from recording devices. Based on these video feeds, a video stream is produced at production truck device 402. Production truck device 402 furthermore includes functionalities, through a user interface, that facilitate the addition of external data into the video streams. The external data may be advertisements, metadata, graphical overlays, score tickers, imported comments, social media input, and statistics. Once external data has been inserted into the video stream, production truck device 402 will encode the video stream and transmit the encoded video stream to video server 404. In an embodiment, production truck device 402 may transmit the encoded video stream directly to end user devices 408.

Video server 404 transcodes the encoded video stream into various video formats so they can be played by end user devices 408. The transcoded video stream may then be transmitted to content distribution network 406. While in certain embodiments, video server 404 may transmit the transcoded video stream directly to end user devices 408, for the sake of efficiency, as content distribution network 406 typically includes a large distributed systems of servers dedicated to streaming content to end user devices 408, higher performance may be attained if end user devices 408 receive video streams via content distribution network 406.

End user devices 408, as shown, may include a video player for playing a received video stream. Playing of the video stream at an end user device 408 may be via a web site 408-1, mobile application 408-2, mobile website 408-3, or widget 408-4.

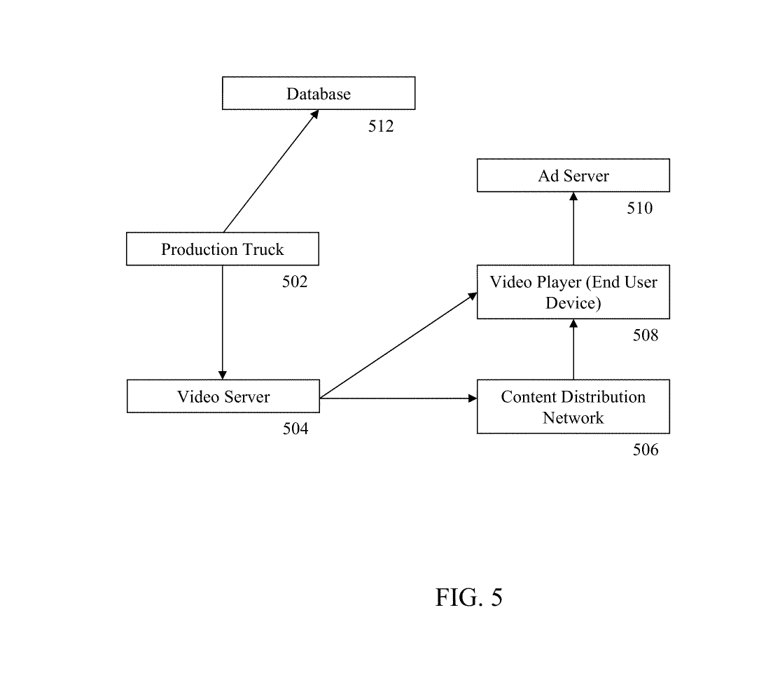

FIG. 5 illustrates a high level depiction an exemplary system for ad insertion into video streams distributed to end users, in accordance with an embodiment of the present disclosure. FIG. 5 illustrates a high level depiction of how advertisement metadata may be used to facilitate the display of advertisements in a video stream at an end user device. Production truck device 502 facilitates the insertion of advertisements into a video stream at a specific time and of a specific length. In an embodiment, the advertisement may be inserted directly at the production truck device 502. A user of production truck device 502, via a user interface, may indicate a specific time and specific length of an advertisement to be inserted. The appropriate advertisement is selected, and inserted to play at the specified time in the video stream and play for the specified length of time.

In another embodiment, production truck device 502 facilitates, via the user interface, insertion of metadata into the video stream, that includes instructions, that when evaluated by end user device 508, causes an advertisement to play in the video stream at a specific time and for a specific length. At a specific point in the video stream, a user of production truck device 502 may elect to insert metadata packets into the video stream. The encoded video stream at the production truck device 502 thus includes the metadata packets. The encoded video stream may thereafter be provided to video server 504.

Video server 504 transcodes the encoded video stream into different formats appropriate for any of a plurality of different end user devices. The metadata packets within the encoded video stream may also be converted. Video server 504 then transmits the video stream to content distribution network 506 to transmit to end user device 508, or transmits the video stream directly to end user device 508.

Once end user device 508 receives the video stream, the video stream may be played by a video player of end user device 508. when the video player encounters the metadata packets, the video player evaluates the metadata packets to determine which advertisement to play. The metadata packets may include an indication of the geographic location of the event in the video stream, certain individuals included in the video stream, or information related to the type of event in the video stream. The metadata packets may also include instructions to retrieve data from the end user device 508 itself, such as information relating to a user of end user device 508. This information may include purchasing or media consumption preferences, such as what types of video streams the user typically views. The information may also include demographic information such as age group, household income, net worth, as well as information relating to different topics of interest. Based on this information and the metadata packets, end user device 508 determines a type of advertisement to request from an ad server 510.

Ad server 510 may then receive a request for an advertisement from end user device 508. The ad server 510 will then return the address for playing the advertisement to end user device 508. End user device 508 may at this point play the advertisement.

Once the advertisement has been played, ad server 510 or end user device 508 may transmit an indication that the advertisement was played to database 512. Database 512 thus stores a log of all advertisements that have been triggered in order to keep track of what advertisements are played at certain end user devices and which video streams requested the specific advertisements.

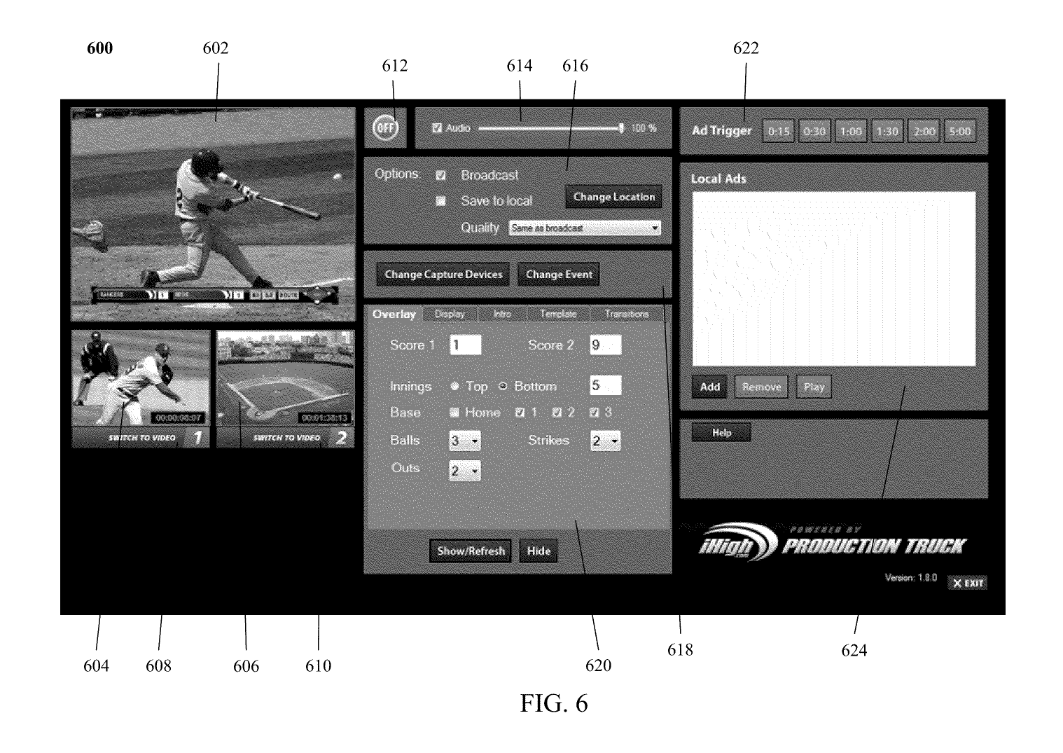

FIG. 6 depicts an exemplary display of a production truck user interface, in accordance with an embodiment of the present disclosure. User interface 600 as shown, represents an exemplary user interface provided by a user interface unit of a production truck device to a user to control encoding of video streams and insertion of external data into video streams. Display 602 represents a main display used for a video stream. Display 602 thus represents the video stream that is to be encoded and transmitted to either a video server, content distribution network, or directly to an end user device. Displays 604 and 606 each represent a different video feed from a recording device. Each video feed shown by displays 604 and 606 may be selected by activating an icon represented by 608 and 610, respectively. Activation of the icon switches the video feed to the video stream shown by display 602, which will be updated accordingly to represent the change.

Recording icon 612 allows a user to start or stop recording or production of any given video stream. Audio control section 614 allows a user to control the volume of the audio corresponding with the video stream. Options section 616 allows a user the ability to broadcast the video stream to end users or alternatively broadcast the video stream locally and save the video stream locally to the production truck device.

Device change section 618 allows a user to change the current devices used for providing video feeds for the video stream. Device change section 618 also allows the user to change the event associated with the video stream. This results in an update of the external data section 620, which is used to add external data to the video stream for display.

Overlay section 620, as shown, provides options to a user for inserting an overlay with data relating to the video stream. In this example, the video stream is of a baseball game and the overly relates to statistics and scoring for a baseball game. A user may edit and update certain characteristics such as scores, innings, who is on base, number of balls, outs, and strikes.

Advertisement section 622 provides a user with options to insert an advertisement or advertisement metadata into the video stream. As the video stream is being produced, a user may select an option associated with the length of a slot for an advertisement. Selection of the option causes insertion of an advertisement slot or advertisement metadata into the video stream at the point in time of the video stream when the user selected the option. As shown, the lengths of time may range from 15 seconds up to 5 minutes. Additionally, in other embodiments, it is contemplated that the lengths in time may range from any number of seconds to any number of minutes consistent with lengths of times typically used for advertisements.

Local ad insertion section 624 provides a user the ability to insert local advertisements. The local advertisements may be selected by the user based on the event in the video stream and the location of the event in the video stream. From the local ad insertion section 624, the advertisements may be queued up for play in the video stream at specified times.

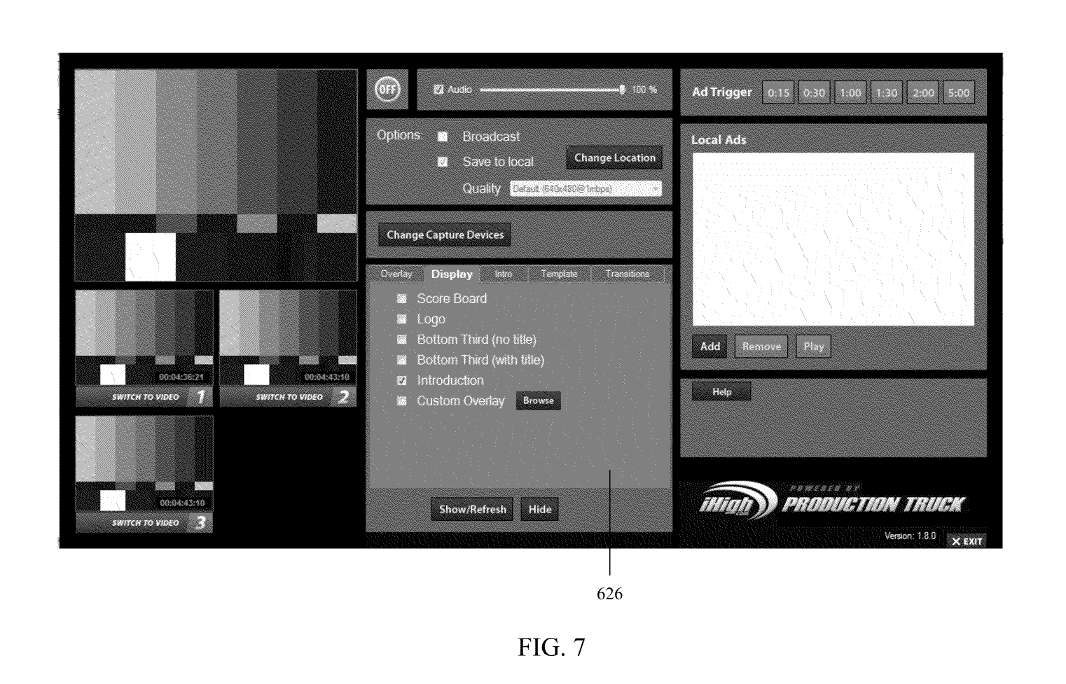

FIG. 7 depicts an exemplary display of a production truck user interface, in accordance with an embodiment of the present disclosure. FIG. 7 displays the same user interface as that depicted by FIG. 6. The main difference is that instead of overlay section 620, a display section 626 is shown. Display section 626 includes options for how to display the contents of overlay section 620 in a given video stream. Certain options are given to display the contents of overlay section 620 in the video stream as a score board, a logo, in the bottom third of the video stream with a title, in the bottom third of the video stream without a title, as an introduction in the beginning of the video stream, or as a custom overlay comprising a user selected overlay based on overlays that have been designed and stored either locally at a production truck device or at an associated database.

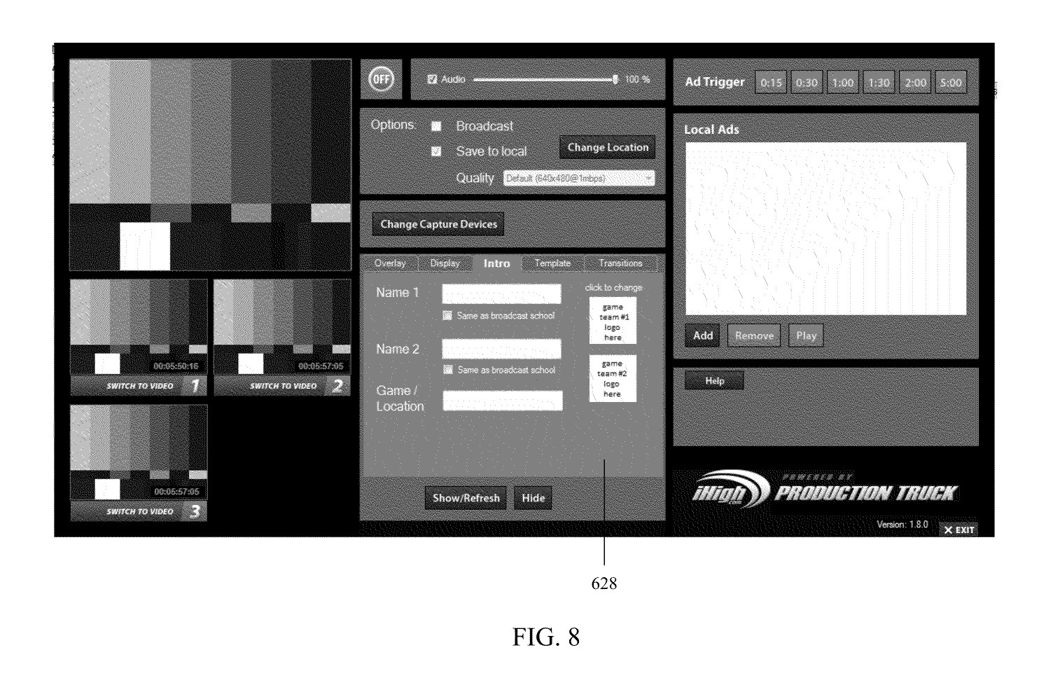

FIG. 8 depicts an exemplary display of a production truck user interface, in accordance with an embodiment of the present disclosure. FIG. 8 displays the same user interface as those depicted by FIGS. 6 and 7. FIG. 8 shows an intro section 628 where overlay section 620 and display section 626 are shown in FIGS. 6 and 7, respectively. Intro section 628 allows a user of a production truck device to insert names of opposing teams for a sporting event, or provide other names such as names of performers for an entertainment event. Logos may also be selected. Based on the information input, this information, including graphical logos, may be inserted and displayed in the video stream.

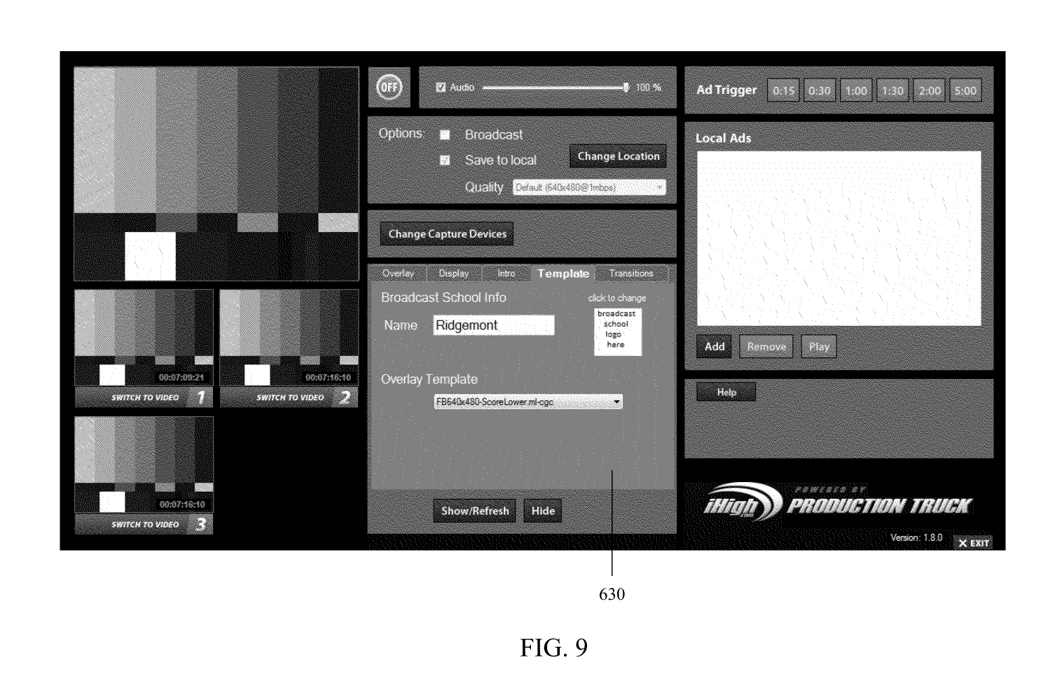

FIG. 9 depicts an exemplary display of a production truck user interface, in accordance with an embodiment of the present disclosure. FIG. 9 displays the same user interface as those depicted by FIGS. 6, 7, and 8. FIG. 9 shows a template section 630 where overlay section 620, display section 626, and intro section 628 are shown in FIGS. 6, 7, and 8, respectively. Template section 630 allows a user to insert a template for a particular broadcast. The template may typically be affiliated with a team or an entertainment entity of an event shown in the video stream.

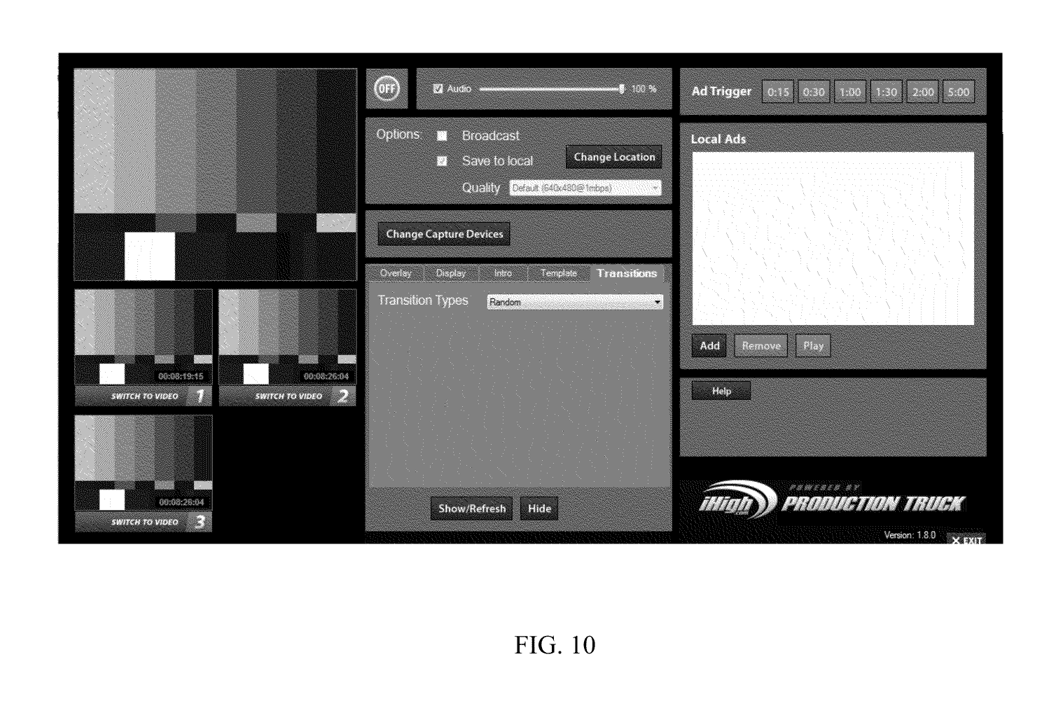

FIG. 10 depicts an exemplary display of a production truck user interface, in accordance with an embodiment of the present disclosure. FIG. 10 displays the same user interface as those depicted by FIGS. 6, 7, 8, and 9. FIG. 10 shows a transitions section 632 where overlay section 620, display section 626, intro section 628, and template section 630 are shown in FIGS. 6, 7, 8, and 9, respectively. Transitions section 632 allows a user to select the appropriate type of transition for an overlay, score box, or template to appear in the video stream. An example of a transition may be fading, or checkerboard, or random. Any transition contemplated by one skilled in the art may be used.

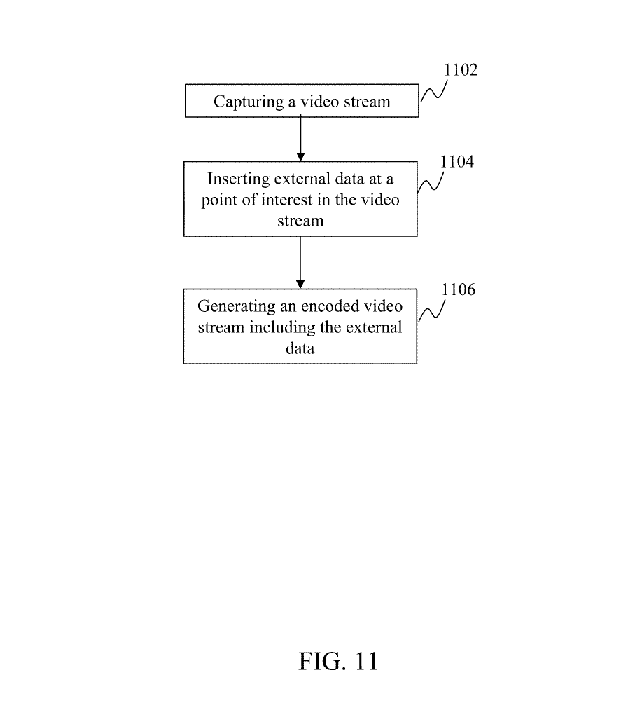

FIG. 11 depicts an exemplary process for generating an encoded video stream, in accordance with an embodiment of the present disclosure. The following process may be carried out by a production truck device as described in accordance with the embodiments set forth herein, as well as by a computing device comprising at least a processor and memory. At 1102, a video stream is captured. The video stream may be captured from any of a plurality of video feeds from recording devices. At 1104, external data is inserted at a point of interest in the video stream. The point of interest may represent a point in the video stream where an advertisement is desired, where display of information related to an individual in the video stream is desired, where display of comments from external sources is desired, or where display of statistics is desired. At 1106, an encoded video stream is generated including the external data that has been inserted. The encoded video stream may then be transmitted to a video server for formatting into any of various formats for video players of end user devices to play the video stream.

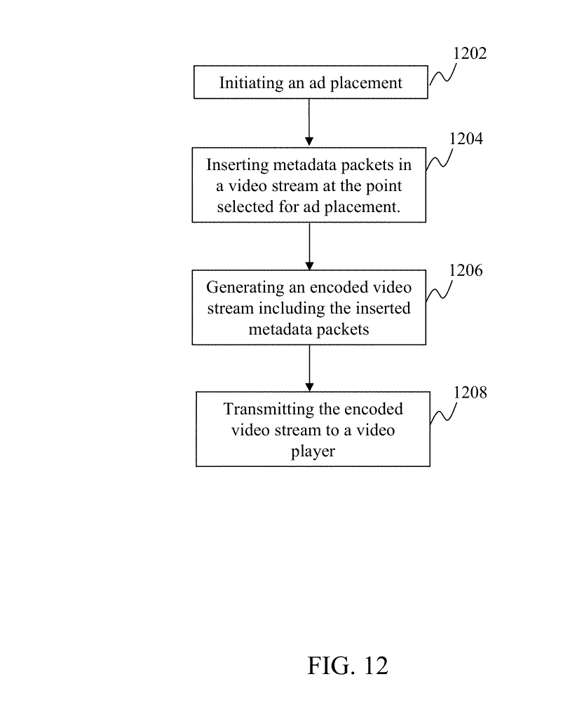

FIG. 12 depicts an exemplary process for initiating ad placement and transmitting an encoded video stream, in accordance with an embodiment of the present disclosure. The following process may be carried out by a production truck device as described in accordance with the embodiments set forth herein, as well as by a computing device comprising at least a processor and memory. At 1202, an ad placement is initiated. Ad placement is initiated by a selection of a point in the video stream where an advertisement is to be placed. At 1204, metadata packets are inserted in the video stream at the point selected for ad placement. The metadata packets facilitate insertion of an appropriate advertisement in the video stream when the video stream is played at an end user device, in accordance with the embodiments described herein. At 1206, an encoded video stream is generated including the inserted metadata packets. At 1208, the encoded video stream is transmitted to a video player of an end user device. When the video player detects the metadata packets and evaluates the metadata packets, the video player will request the appropriate advertisement from an ad server, in accordance with the embodiments described herein.

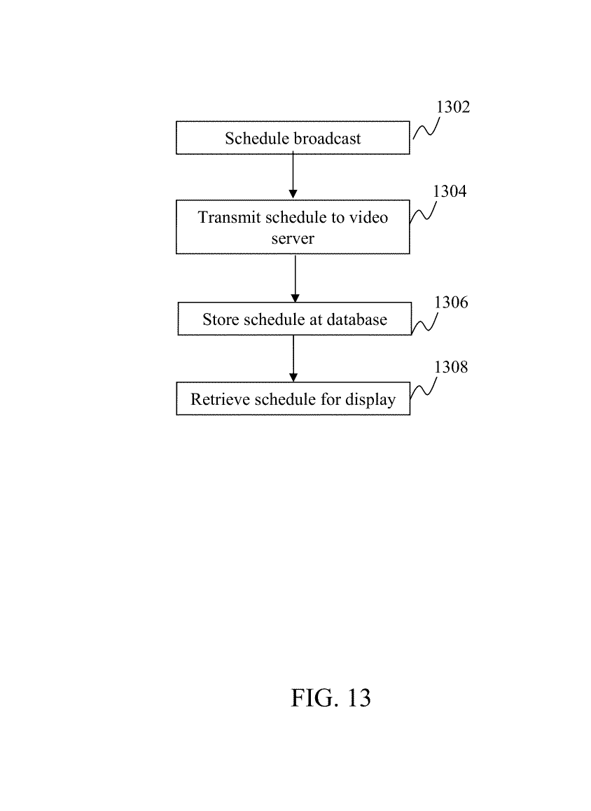

FIG. 13 depicts an exemplary process for scheduling broadcasts of video streams, in accordance with an embodiment of the present disclosure. The following process may be carried out by a production truck device as described in accordance with the embodiments set forth herein, as well as by a computing device comprising at least a processor and memory. At 1302, a broadcast of a video stream is scheduled. At 1304, the schedule is transmitted to a video server from a production truck device. At 1306, the schedule is stored at a database 1306. At 1308, the schedule is retrieved for display. The schedule may be retrieved purely for display purposed by a user to see when the broadcast of the video stream will take place. Alternatively, the schedule may be retrieved in order for the broadcast to be rescheduled or deleted. New broadcasts may also be added. Additionally, extra information regarding the broadcast may be added to form a more complete and user friendly schedule.

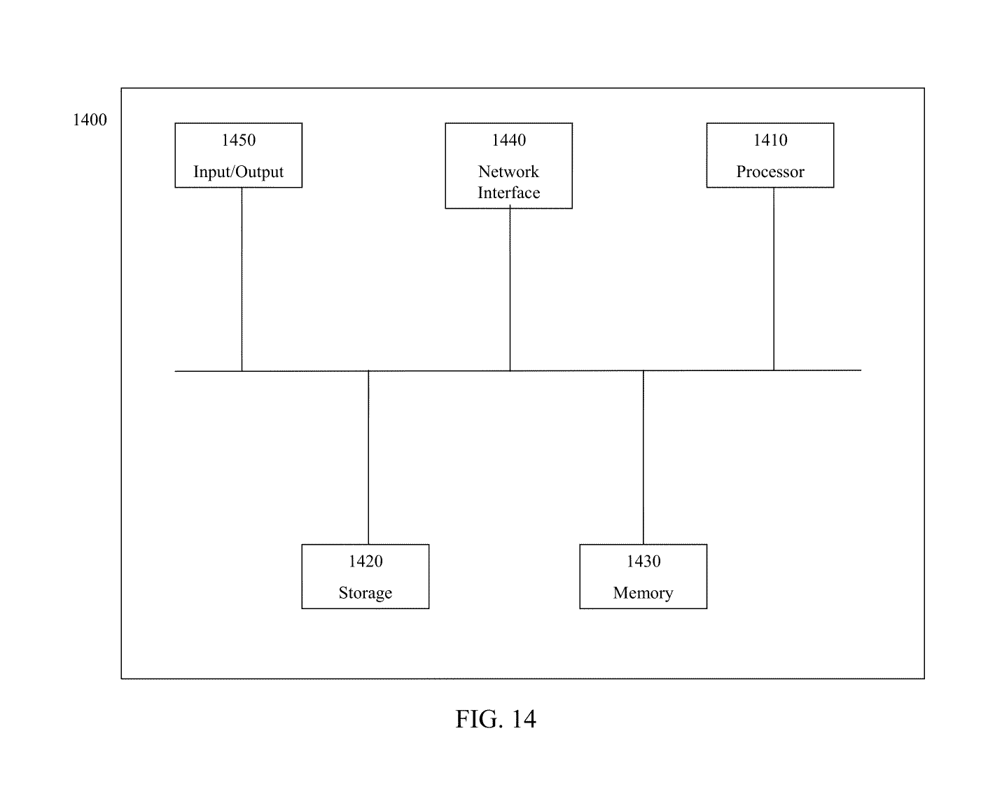

The above-described embodiments for encoding video streams, inserting external data into video streams, and inserting advertisements or metadata packets into video streams can be implemented on a computer using well-known computer processors, memory units, storage devices, computer software, and other components. A high-level block diagram of such a computer is illustrated in FIG. 14. Computer 1400 contains a processor 1410, which controls the overall operation of the computer 1400 by executing computer program instructions, which define such operations. The computer program instructions may be stored in a storage device 1420, or other computer readable medium (e.g., magnetic disk, CD ROM, etc.), and loaded into memory 1430 when execution of the computer program instructions is desired. Thus, any of the processes described herein can be defined by the computer program instructions stored in the memory 1430 and/or storage 1420 and controlled by the processor 1410 executing the computer program instructions. For example, the computer program instructions can be implemented as computer executable code programmed by one skilled in the art to perform collection and analysis of application usage. Accordingly, by executing the computer program instructions, the processor 1410 executes an algorithm for collecting and analyzing application usage as described herein. Computer 1400 may also perform other functionalities, such as those described above in connection with all Figures corresponding to the embodiments described herein. The computer 1400 also includes one or more network interfaces 1440 for communicating with other devices via a network. The computer 1400 also includes input/output devices 1450 that enable user interaction with the computer 1400 (e.g., display, keyboard, mouse, speakers, buttons, etc.) One skilled in the art will recognize that an implementation of an actual computer could contain other components as well, and that FIG. 14 is a high level representation of some of the components of such a computer for illustrative purposes.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim and all applications, modifications and variations that fall within the true scope of the present teachings.

1. A method for video broadcast production implemented by a computing device, comprising:
capturing a video stream;
inserting external data at a point of interest in the video stream, the external data facilitating display of content from an external source at the point of interest in the video stream; and
generating an encoded video stream including the external data inserted at the point of interest in the video stream.

2. The method of claim 1, capturing a video stream comprises:
capturing a video stream at a production truck device comprising a video capture unit.

3. The method of claim 2, wherein the video capture unit is configured to execute on at least one of: a desktop computing device, a mobile computing device, or via a web browser enabled device via a web browser.

4. The method of claim 1, further comprising
determining the point of interest in the video stream based on an identified specific time in the video stream to insert an advertisement of a specific length.

5. The method of claim 4, wherein inserting external data at the point of interest in the video stream comprises:
inserting metadata at the point of interest in the video stream, wherein the metadata, when evaluated by a video player, allows the video player to request an advertisement.

6. The method of claim 1, wherein inserting external data at the point of interest in the video stream comprises:
inserting a score ticker including local scores associated with select local games associated with an event shown in the video stream.

7. The method of claim 1, wherein inserting external data at the point of interest in the video stream comprises:
inserting statistics related to an event shown in the video stream from an external source, wherein the external source is at least one of: an electronic stadium scoreboard or an official statistics computer feed from a scorekeeper.

8. The method of claim 1, wherein inserting external data at the point of interest in the video stream comprises:
inserting imported comments related to an event shown in the video stream, the imported comments received from users via text message or email.

9. The method of claim 1, wherein inserting external data at the point of interest in the video stream comprises:
inserting a live video feed from an external source, the live video feed being related to an event shown in the video stream.

10. The method of claim 1, wherein inserting external data at the point of interest in the video stream comprises:
inserting a graphical template within the video stream.

11. The method of claim 1, further comprising:
transmitting the encoded video stream to a video server for distribution.

12. The method of claim 1, further comprising:
transmitting the encoded video stream to a central distribution network for distribution.

13. The method of claim 1, further comprising:
transmitting the encoded video stream to a video player of a user to play the encoded video stream.

14. The method of claim 13, wherein the video operates in at least one of: a website, a mobile application, a mobile website, or a widget within an application.

15. A system for encoding and streaming video streams, comprising:
a video capture unit configured for capturing a video stream, inserting external data in the video stream, and encoding the video stream including the external data;
a video server configured for distributing the encoded video stream; and
a database configured for storing information related to the video stream, the external data, and distribution of the video stream.

16. The system of claim 15, further comprising:
a user interface unit, coupled to the video capture unit, configured for determining a point of interest in the video stream; and facilitating insertion of the external data at the point of interest in the video stream, the external data facilitating display of content from an external source at the point of interest in the video stream.

17. The system of claim 15, wherein the system is at least one of: a desktop computing device, a mobile computing device, or a web browser enabled device.

18. The system of claim 15, wherein the system further comprises:
an advertisement unit configured for inserting metadata at a point of interest in the video stream, wherein the metadata, when evaluated by a video player, allows a video player to request an advertisement.

19. The system of claim 15, further comprising:
a user interface unit, coupled to the video capture unit, configured for inserting a score ticker including local scores associated with select local games associated with an event shown in the video stream.

20. The system of claim 15, further comprising:
a user interface unit, coupled to the video capture unit, configured for inserting statistics related to an event shown in the video stream from an external source, wherein the external source is at least one of: an electronic stadium scoreboard or an official statistics computer feed from a scorekeeper.

21. The system of claim 15, further comprising:
a user interface unit, coupled to the video capture unit, configured for inserting imported comments related to an event shown in the video stream, the imported comments received from users via text message or email.

22. The system of claim 15, further comprising:
a user interface unit, coupled to the video capture unit, configured for inserting a graphical template tailored for content within the video stream.

23. The system of claim 15, wherein the video server is configured for transmitting the encoded video stream to a central distribution network for distribution.

24. The system of claim 15, wherein the video server is configured for formatting the encoded video stream in at least one format of a plurality of formats; and transmitting the formatted encoded video stream to a video player.

25. The system of claim 15, further comprising:
an advertisement server for storing third party advertisements; and
wherein the video capture unit is further configured for retrieving third party advertisements from the advertisement server; and inserting the third party advertisements into the video stream.

26. The system of claim 15, wherein the system further comprises:
a video player configured for receiving the encoded video stream from the video server.

27. The system of claim 26, wherein the video player resides in at least one of: a website, a mobile application, a mobile website, or a widget within an application.

28. The system of claim 15, further comprising:
a user interface unit, coupled to the video capture unit, configured for inserting metadata into the video stream, wherein the metadata, when evaluated by a video player playing the video stream, causes the video player to retrieve an advertisement from an advertisement server to play in the video stream at a particular time for a particular length.

29. The system of claim 28, wherein the database is further configured to receive an indication that the metadata caused an advertisement to be played at the video player.

30. The system of claim 15, wherein the video player retrieves the advertisement form the advertisement server based on an analysis of media consumption preferences of a user of the video player.

31. The system of claim 15, further comprising:
a scheduler configured for scheduling a broadcast of the video stream.

32. The system of claim 31, wherein the scheduler comprises a web application accessible by a user to schedule the broadcast of the video stream or edit an existing schedule.

33. The system of claim 31, wherein the database is further configured to store broadcast schedules generated by the scheduler.

34. The system of claim 31, further comprising:
a web scheduler unit configured for facilitating updates to broadcast schedules stored in the database; and adding new broadcast schedules to the database

35. The system of claim 31, further comprising:
a video management system configured for providing a user interface to at least one of: allow a user to associate additional information with the video stream, set limits on distribution of the video stream, and access analytics relating to the video stream

36. The system of claim 15, wherein the external data comprises data associated with a score operator, wherein the data facilitates live updates to a video player playing the video stream in response to the score operator updating the data.

37. The system of claim 15, wherein the external data comprises an instruction to update a graphical interface of a video player.

38. The system of claim 15, wherein the video capture unit is further configured for receiving a plurality of video feeds from a plurality of recording devices.

39. A machine readable non-transitory and tangible medium for encoding and streaming video streams, including information, that when executed, causes the machine to perform the steps of:
capturing a video stream;
inserting external data in the video stream, the external data facilitating display of content from an external source in the video stream; and
generating an encoded video stream including the external data inserted in the video stream.

40. The machine readable non-transitory and tangible medium of claim 39, wherein the information causing the machine to perform capturing a video stream comprises information causing the machine to perform the steps of:
allowing a user to switch between a plurality of different recording devices to provide a feed to the video stream;
selecting one of the plurality of different recording devices to provide the feed to the video stream.

41. The machine readable non-transitory and tangible medium of claim 39, wherein the information causing the machine to perform inserting external data in the video stream comprises information causing the machine to perform the steps of:
selecting a point of interest within the video stream; and
inserting the external data at the point of interest.

42. The machine readable non-transitory and tangible medium of claim 41, wherein the external data comprises at least one of: an overlay, overlay images, local advertisements, or metadata for instructing a video player to retrieve an advertisement.

43. The machine readable non-transitory and tangible medium of claim 41, wherein the information causing the machine to perform selecting a point of interest within the video stream comprises information causing the machine to perform the step of:
receiving an input indicating a point of interest based on a specified time in the video stream.

44. The machine readable non-transitory and tangible medium of claim 41, wherein the information causing the machine to perform inserting external data in the video stream comprises information causing the machine to perform the steps of:
inserting a score ticker including local scores associated with select local games associated with an event shown in the video stream.

45. The machine readable non-transitory and tangible medium of claim 41, wherein the information causing the machine to perform inserting external data in the video stream comprises information causing the machine to perform the step of:
inserting statistics related to an event shown in the video stream from an external source, wherein the external source is at least one of: an electronic stadium scoreboard or an official statistics computer feed from a scorekeeper.

46. The machine readable non-transitory and tangible medium of claim 41, wherein the information causing the machine to perform inserting external data in the video stream comprises information causing the machine to perform the step of:
inserting imported comments related to an event shown in the video stream, the imported comments received from users via text message or email.

47. The machine readable non-transitory and tangible medium of claim 41, wherein the information causing the machine to perform inserting external data in the video stream comprises information causing the machine to perform the step of:
inserting a live video feed from an external source, the live video feed being related to an event shown in the video stream.

48. The machine readable non-transitory and tangible medium of claim 41, wherein the information causing the machine to perform inserting external data in the video stream comprises information causing the machine to perform the step of:
inserting a graphical template tailored for content within the video stream.

49. The machine readable non-transitory and tangible medium of claim 39, wherein the information, when executed, further causes the machine to perform the step of:
transmitting the encoded video stream to a video server for distribution.

50. The machine readable non-transitory and tangible medium of claim 39, wherein the information, when executed, further causes the machine to perform the step of:
transmitting the encoded video stream to a central distribution network for distribution.

51. The machine readable non-transitory and tangible medium of claim 39, wherein the information, when executed, further causes the machine to perform the step of:
transmitting the encoded video stream to a video player of a user to play the encoded video stream.

52. The machine readable non-transitory and tangible medium of claim 51, wherein the video player may reside on at least one of: a website, a mobile application, a mobile website, or a widget within an application.
